(19) United States
(12) Patent Application Publication
(10) Pub. No.: US 2013/0047704 A1
(43) Pub. Date: Feb. 28, 2013

(54) MULTI-FUNCTIONAL VEHICLE FOR MEASURING AIR POLLUTION

(71) Applicants: Gwi Nam Bae, Seoul (KR); Seung Bok Lee, Seoul (KR); Hyoun Cher Jin, Seoul (KR); Seung Jae Lee, Jeju-si (KR); Dong Hun Lee, Goyang-si (KR); Dong Chun Shin, Seoul (KR); Seok Hwan Lee, Daejeon (KR); Chang Soo Kim, Seoul (KR)

(72) Inventors: Gwi Nam Bae, Seoul (KR); Seung Bok Lee, Seoul (KR); Hyoun Cher Jin, Seoul (KR); Seung Jae Lee, Jeju-si (KR); Dong Hun Lee, Goyang-si (KR); Dong Chun Shin, Seoul (KR); Seok Hwan Lee, Daejeon (KR); Chang Soo Kim, Seoul (KR)

(73) Assignee: KOREA INSTITUTE OF SCIENCE AND TECHNOLOGY, Seoul (KR)

(21) Appl. No.: 13/586,547

(22) Filed: Aug. 15, 2012

(30) Foreign Application Priority Data
Aug. 24, 2011 (KR) 10-2011-0084775

(51) Int. Cl. G01N 1/22

(52) U.S. Cl. 73/31.02

(57) ABSTRACT

Provided is a multi-functional vehicle including: a sampling unit through an external air flows in, the sampling unit having a particle sampling inlet tube and a gas sampling inlet tube; a flow distribution unit for supplying the air flowing in through the particle sampling inlet tube to a particle measuring device; a manifold for supplying the air flowing in through the gas sampling inlet tube to a gas measuring device; a particle measuring device for measuring particles in the air supplied from the flow distribution unit; a gas measuring device for measuring gas in the air supplied from the manifold; an animal exposure chamber system for receiving the air from at least one of the flow distribution unit and the manifold and performing an animal exposure experiment; and a data management unit for storing and monitoring air pollution data measured by the particle measuring device and the gas measuring device.

### CROSS-REFERENCE TO RELATED APPLICATION

This application claims priority to Korean Patent Application No. 10-2011-0084775, filed on Aug. 24, 2011, and all the benefits accruing therefrom under 35 U.S.C. §119, the contents of which in its entirety are herein incorporated by reference.

### BACKGROUND

1. Field

The present disclosure relates to a multi-functional vehicle for measuring air pollution, and more particularly, to a vehicle for measuring air pollution, which may monitor the change of an air pollution level in time and space in a stop mode and a running mode and have a car chase function which allows measuring an air pollution level caused by a specific car. In addition, the present disclosure relates to a multi-functional vehicle for measuring air pollution, which allows an animal exposure experiment during actual running on a road or staying at the roadside, and ensures exact evaluation of a health risk caused by vehicle-related air pollution.

2. Description of the Related Art

In the modern society, a car is one of very important means of transportation. Recently, air pollution at the center of a city or on main roads is on the rise due to the increase of individual cars. At present, nations and local governments operate air pollution monitoring stations in order to monitor an air pollution level. The air pollution monitoring stations are fixed and may be classified into an urban air pollution monitoring station and a roadside air pollution monitoring station.

Generally, the fixed urban air monitoring station measures an air pollution level evened off by diffusion and dilution. Therefore, the influence of car exhaust gas on urban air pollution may not be easily distinguished. For example, in the case of Seoul in the Republic of Korea, one urban air monitoring station is operated in each administrative district so that the concentration of SO₂, CO, NO₂, and fine particulate matters (PM₁₀) are measured as the criteria air pollutants. However, the contribution of vehicles to the air pollution level may not be easily distinguished only from the data, and it is difficult to evaluate the effect of vehicles on the air pollution level at the entire district in detail.

In addition, the fixed roadside air pollution monitoring stations are located at crossroads having much traffic, arterial roads representing the district, roads passing through a residential area, and points having much traffic of heavy-duty vehicles to measure criteria air pollutants such as SO₂, CO, NO₂, and fine particulate matters (PM₁₀) in order to monitor the air pollution by cars. However, since the monitoring stations are fixed, it is impossible to check the spatial distribution of pollution levels on roads or at roadsides in a wide administrative district. For this reason, it is impossible to figure out the spatial distribution of pollution levels exposed to drivers or passengers, and so it is not easy to evaluate the health risk in detail.

Meanwhile, some local governments such as Seoul, Inchon and Pusan in the Republic of Korea operate air pollution measurement vehicles. In this case, measurement vehicles stop in an area where the automatic air pollution monitoring network is not in service, locations requested by local residents, or places where air pollution might be severe, and measures criteria air pollutants, heavy metals and volatile organic compounds. In relation to the measurement vehicle, Korean Patent Registration No. 10-0996513 [Patent Literature 1] discloses a technique of mounting an air pollution monitoring device to an integrated mast installed at the top of a vehicle so that the vehicle moves to a measurement point and then measures air pollution.

However, the measurement vehicle does not have a running mode which allows measuring concentrations of air pollutants while running on the road. Since the vehicle stops at the measurement point to perform measurement, it is impossible to measure the spatial distribution of pollution levels over a wide area within a short time.

Accordingly, a technique of measuring an air pollution level during running has been recently attempted. In relation to this running mode, Korean Patent Registration No. 10-0582592 [Patent Literature 2] discloses a technique of installing sampling holes at a front side of a running car and at a rear side of a tire to measure the concentration of air samples, and then calculates the difference in concentration of the sample to measure an amount of suspended road dust which is re-suspended from the road due to the running of the vehicle. In addition, Korean Unexamined Patent Publication No. 10-2010-0031375 [Patent Literature 3] proposes a technique of loading a mobile ubiquitous sensor network to a moving vehicle to measure an air pollution level of a corresponding district in real time during running

In the case of the above running mode, since the air pollution level can be measured during running, the spatial distribution of air pollution levels may be figured out. However, in the case of Patent Literature 2, only suspended road dust generated by a corresponding car is measured, and it is impossible to measure the air pollution level caused by other pollution sources (cars). In addition, in the case of Patent Literature 3, the spatial distribution of air pollution levels may be measured in real time and stored as a database, but it is difficult to exactly measure the concentrations of particulate pollutants and gaseous pollutants included in the air, and it is impossible to measure the air pollution level caused by a specific car.

Meanwhile, in order to evaluate a health risk of air pollutants exhausted from a car, an animal exposure experiment is generally performed. In the animal exposure experiment, nanoparticles exhausted from the car are collected in a filter and eluted, and then animal toxic and cell toxic experiments are performed. However, the properties of particulate samples used in the experiments may be different from those of nanoparticles exhausted from a car on the road, and particularly different from the actual situation in the air containing pollutants. Therefore, the accuracy and objectivity of the experiments may be deteriorated.

### Related Documents

Patent Literatures

Patent Literature 1: Korean Patent Registration No. 10-0996513

Patent Literature 2: Korean Patent Registration No. 10-0582592

Patent Literature 3: Korean Patent Publication No. 10-2010-0031375

### SUMMARY

The present disclosure is directed to providing a multi-functional vehicle for measuring air pollution, which may monitor the change of an air pollution level in time and space in a stop mode and a running mode, have a car chase function which allows examining emission characteristics of a specific target car, and animal exposure experiment function which expose the roadside air directly to animals to obtain health effect data of vehicle exhaust so that a health risk may be accurately evaluated.

In one aspect, there is provided a multi-functional vehicle, which includes: a particle sampling inlet tube and a gas sampling inlet tube through which an external air flows in, the particle sampling inlet tube and a gas sampling inlet tube having a particle sampling hole and a gas sampling hole, respectively, at the end of each inlet tube; a flow distribution unit for supplying the air flowing in through the particle sampling inlet tube to particle measuring devices; a manifold for supplying the air flowing in through the gas measuring inlet tube to gas measuring devices; particle measuring devices for measuring particles in the air supplied from the flow distribution unit; gas measuring devices for measuring gas in the air supplied from the manifold; an animal exposure chamber for receiving the air from at least one of the flow distribution unit and the manifold and performing an animal exposure experiment; and a data management unit for storing and monitoring air pollution data measured by the particle measuring devices and the gas measuring devices.

The flow distribution unit may include: a coupling tube connected to the particle sampling inlet tube; a flow distribution plenum formed at the rear end of the coupling tube; and a sampling tube for distributing the air flowing into the flow distribution plenum to the particle measuring device. In addition, the sampling tube may include: a sample inlet port located in an inner space of the flow distribution plenum; and a sample supply tube extending from the sample inlet port and supplying the air to the particle measuring device.

At least one sampling inlet may be selected among three kinds of sampling inlet such as a stop mode sampling inlet, a running mode sampling inlet, and a car chase mode sampling inlet, and may include all of the three sampling inlets.

The particle sampling inlet may include: a sampling line connected to the flow distribution unit; and an inlet hole formed at the end of the sampling line and having a smaller inner diameter than the sampling line.

According to the present disclosure, in the stop mode and the running mode, the change of air pollution levels in time and space may be accurately monitored, and a health risk caused by the air pollution may be accurately evaluated since a car chase function for measuring an air pollution level caused by a specific car is provided and the air pollutants exhausted from the car actually running on a road are directly exposed to an animal to ensure exact animal exposure experiment measurement data.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view showing basic components of a multi-functional vehicle for measuring air pollution according to the present disclosure;

FIG. 2 is a schematic view showing layout of a multi-functional vehicles for measuring air pollution according to an embodiment of the present disclosure;

FIG. 3 is a diagram showing a flow distribution unit of a multi-functional vehicles for measuring air pollution according to an embodiment of the present disclosure;

FIG. 4 is sectional views taken along the lines A-A, B-B, C-C and D-D of FIG. 3; FIG. 5 shows an example of the arrangement of each device employed in the multi-functional vehicle according to an embodiment of the present disclosure;

FIG. 6 shows an exemplary implementation of an animal exposure chamber employed in the multi-functional vehicle according to an embodiment of the present disclosure;

FIG. 7 shows an exemplary implementation of an optional sampling inlet for measuring air pollution at the height of about 3 m from the road ground in order to examine the effect of sampling height on the measured air pollution data.

FIG. 8 is a schematic view exemplarily showing a power supply system employed in the multi-functional vehicle according to an embodiment of the present disclosure;

FIG. 9 is a photograph exemplarily showing the upper portion of the multi-functional vehicle according to an embodiment of the present disclosure, which depicts a mounting location of a sampling inlet; and

FIGS. 10a to 10e are software screens showing measurement results, displayed as graphs in real time, which are measured and stored by a data management unit employed in the multi-functional vehicle according to an embodiment of the present disclosure.

[Detailed Description of Main Elements]

| | |
|---|---|
| 100, 110, 120, 130: sampling inlet | |
| P110, P120, P130: particle sampling tube | |
| G110, G120, G130: gas sampling tube | |
| 170: laminar flow meter | |
| 180: ventilator controller | |
| 200: flow distribution unit | 220: coupling tube |
| 240: flow distribution plenum | 260: sampling tube |
| 300: manifold | 400: particle measuring device |
| 500: gas measuring device | 600: animal exposure |
| | chamber system |
| 700: data management unit | 800: power supply system |

### DETAILED DESCRIPTION

Hereinafter the present disclosure will be described in detail with reference to the accompanying drawings. The accompanying drawings show exemplary embodiments of the present disclosure, which are provided for better understanding of the present disclosure and not intended to limit the scope of the present disclosure.

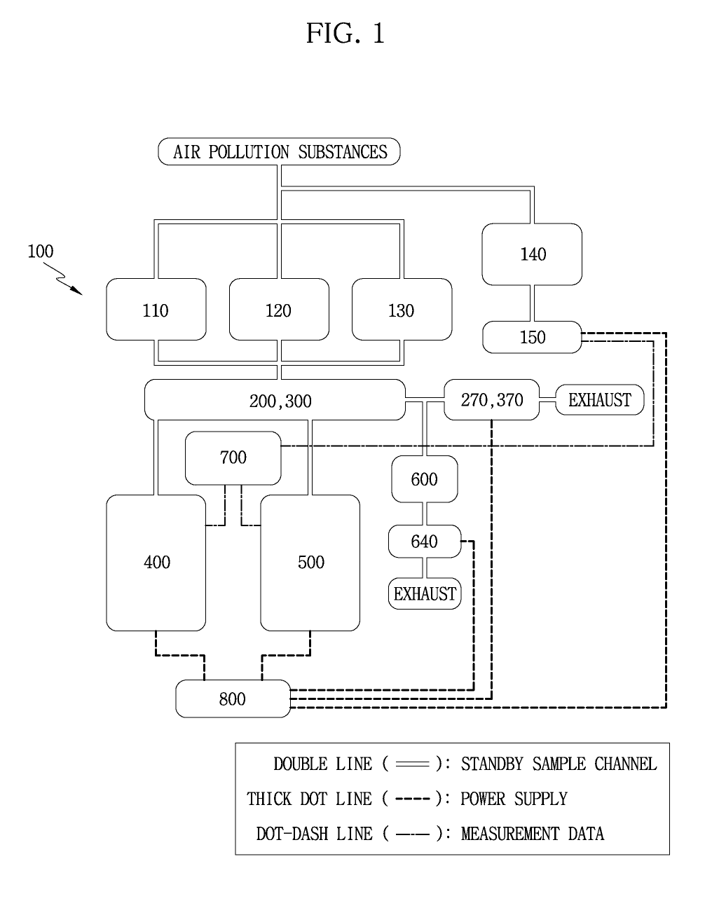

Referring to the accompanying drawings, a multi-functional vehicle for measuring air pollution according to the present disclosure (hereinafter, referred to as a ‘multi-functional vehicle’) includes a sampling inlet 100 through which an external air flows in, a flow distribution unit 200 for supplying the introduced air to a particle measuring device 400, a manifold 300 for supplying the introduced air to a gas measuring device 500, a particle measuring device 400 for measuring particles in the air, a gas measuring device 500 for measuring gas in the air, an animal exposure chamber 600 for performing an animal exposure experiment, and a data management unit 700 for storing the air pollution data measured by the particle measuring device 400 and gas measuring device 500 and displaying the air pollution data as a graph in real time, as shown in FIG. 1.

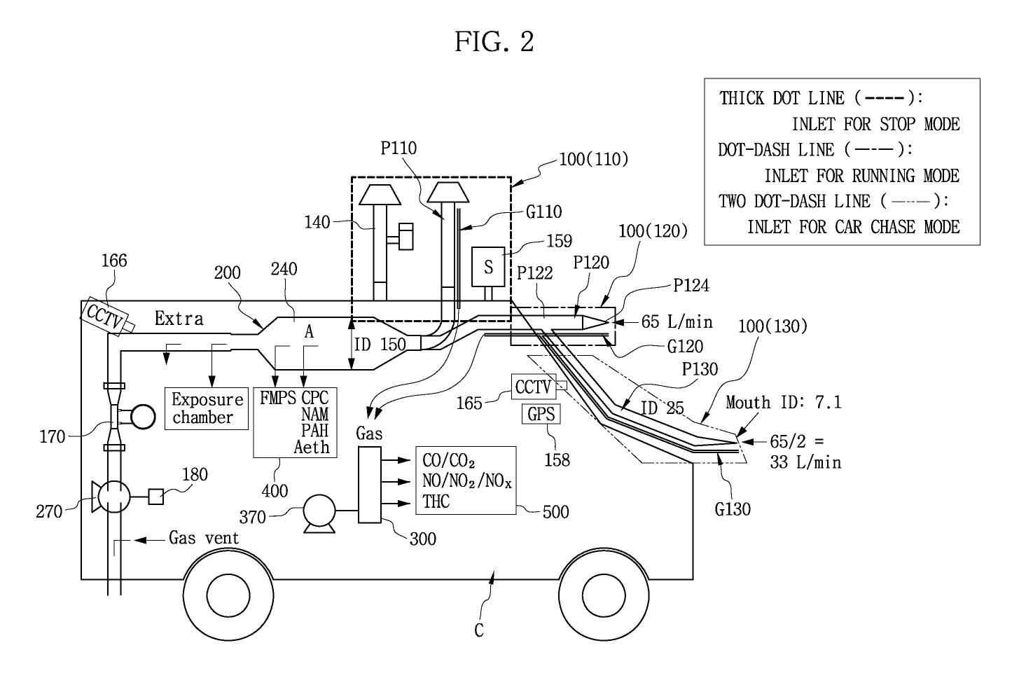

The components are loaded on a vehicle C, as shown in FIG. 2. In the present disclosure, the vehicle C is not limited if it can move in a state where the components are loaded thereon. The vehicle C may be selected from passenger cars, vans, and large/medium/small trucks and buses.

In addition, the multi-functional vehicle according to the present disclosure may further include a power supply system 800 for supplying power to at least one selected from the components. The power supply system 800 should supply power to the particle measuring device 400, the gas measuring device 500 and the data management unit 700, and it may also supply power to other controllers or pumps. The power supply system 800 includes at least a power source. The power source is not limited, and for example may be selected from industrial batteries, power of the vehicle C and power generators. In the case of a stop mode, the power source may be selected from external powers. In addition, the power supply system 800 may further include a charger for charging a power source such as a battery, an inverter for raising the battery voltage from 12V to 220V, and an integrated power management module.

The sampling inlet 100 includes a sampling inlet tube through which an external air flows in. Here, as two sampling inlet tubes, the sampling inlet includes particle sampling inlet tubes P110, P120, P130 and gas sampling inlet tubes G110, G120, G130. In other words, according to the present disclosure, the sampling inlet 100 includes a pair of sampling inlet tubes composed of the particle sampling inlet tubes P110, P120, P130 and the gas sampling inlet tubes G110, G120, G130.

In addition, the sampling inlet 100 is at least one selected from a stop mode sampling inlet 110, a running mode sampling inlet 120 and a car chase mode sampling inlet 130. Moreover, each sampling inlet 110, 120, 130 has a pair of sampling inlet tubes composed of the particle sampling inlet tubes P110, P120, P130 and the gas sampling inlet tubes G110, G120, G130 as described above.

The multi-functional vehicle according to the present disclosure may include all of three sampling inlets 110, 120, 130, and at least one of three sampling inlets 110, 120, 130 is selectively mounted according to the mode when air pollutants are measured. In detail, in the case of the stop mode, namely in the case where the change of air pollution level at a specific location at the roadside according to time is measured, the stop mode sampling inlet 110 is mounted so that the air flows in. In addition, in the case of the running mode, namely in the case where the change of air pollution level on a road during running according to space is measured, the running mode sampling inlet 120 is mounted so that the air flows in. Moreover, in the case of the chase mode, namely in the case where air pollutants exhausted from a specific target car are measured, the car chase mode sampling inlet 130 is mounted so that the air flows in.

According to an embodiment, the stop mode sampling inlet 110 is mounted to the upper portion of the vehicle C as shown in FIG. 2 in order to minimize the influence of the vehicle C. In other words, as shown in FIG. 2, the stop mode sampling inlet tubes P110, G110 may be mounted vertically at the roof of the vehicle C. In addition, the stop mode sampling inlet tube P110, G110 may have, for example, a length of 0.5 to 1.5 m, specifically about 1.0 m.

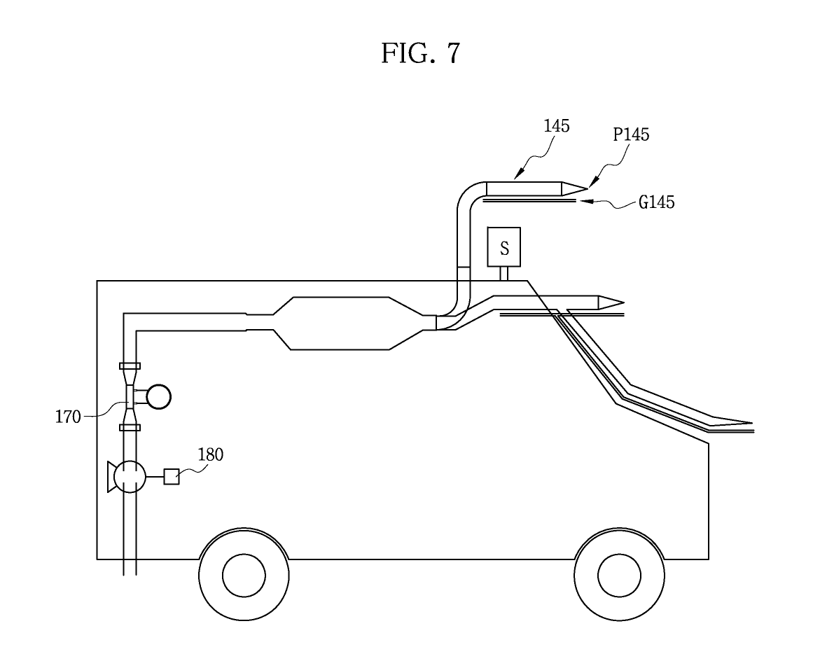

In addition, the running mode sampling inlet 120 is mounted at the front portion of the vehicle C. In other words, as shown in FIG. 2, the running mode sampling inlet tubes P120, G120 are mounted toward the front portion of the vehicle C. In addition, the running mode sampling inlet tubes P120, G120 may be installed horizontally with respect to the ground. In this case, it is possible to obtain sampling in a state where the change of the air flow caused by the vehicle C is as small as possible. There is an optional running mode sampling inlet 145 (FIG. 7) that can be mounted at the roof of the vehicle C where the stop mode sampling inlet 110 is connected for stop mode measurement. The optional running mode sampling inlet can be used to examine the effect of sampling height on the dilution of vehicle exhaust and consequently on the measured air pollution level during running mode measurement.

Moreover, the car chase mode sampling inlet 130 is mounted to the front portion of the vehicle C, and the end of the car chase mode sampling inlet 130 may be located at 0.3 to 1.5 m from the ground. In detail, in the case of the car chase mode, air pollutants exhausted from a specific car to be tested are measured while chasing the car to be tested, and the car chase mode sampling inlet tubes P130, G130 are mounted to face the front portion of the vehicle C so that the sampling inlet tubes P130, G130 are located at 0.3 to 1.5 m from the ground. For example, as shown in FIG. 2, the sampling inlet tubes P130, G130 are installed to closely adhere to the front glass and bumper of the vehicle C, so that its end is located at 0.3 to 1.5 m from the ground. In this case, the sampling inlet tubes P130, G130 are as close to the exhaust tube of the car to be tested as possible so that air pollutants exhausted from the car to be tested may be effectively sampled. The chase mode sampling inlet tubes P130, G130 may be located at about 1.0 m from the ground.

In addition, the car chase mode sampling inlet tubes P130, G130 may be diverged one by one toward both right and left sides of the vehicle C. In detail, the car chase mode sampling inlet tubes P130, G130 is composed of a left branch tube diverging to the left of the vehicle C and a right branch tube diverging to the right vehicle C, which have, for example, a “V” or “Y” shape, so that the sampling inlet tubes P130, G130 are oriented to both right and left sides of the car to be tested. The exhaust tailpipe may be located at a left or right side of a car depending on the kind of the car. In the case where the sampling inlet tubes P130, G130 diverge to both sides as described above, there is no effect of the location of an exhaust tailpipe. Therefore, the emission characteristics of air pollutants according to a certain parameter of a car to be tested, driving conditions such as a vehicle speed, the kind of a after-treatment device or the like may be measured.

In addition, the car chase mode sampling inlet tubes P130, G130 may be formed to diverge from the running mode sampling inlet tubes P120, G120. In detail, as shown in FIG. 2, the particle sampling tube P130 of the car chase mode may diverge from the particle sampling inlet tube P120 of the running mode, and the gas sampling inlet tube G130 of the car chase mode may diverge from the gas sampling inlet tube G120 of the running mode.

Moreover, the car chase mode sampling inlet tubes P130, G130 may not diverge from the running mode sampling inlet tubes P120, G120 but may be detachably mounted to the flow distribution unit 200 or to the manifold 300. In other words, the running mode sampling inlet 120 and the car chase mode sampling inlet 130 may be freely exchanged when being installed to a coupling tube 220 of the flow distribution unit 200. In another embodiment, in the car chase mode, the gas sampling inlet tube G130 may diverge from the gas sampling inlet tube G120 of the running mode, and the particle sampling inlet tube P130 may not diverge from the particle sampling inlet tube P120 of the running mode but may be detachably mounted to the flow distribution unit 200.

Meanwhile, the particle sampling inlet tube P120 of the running mode may include a sampling line P122 connected to the coupling tube 220 of the flow distribution unit 200, and an air inlet hole P124 formed at the end of the sampling inlet tube P120. The inner diameter of the inlet hole P124 may be smaller than the inner diameter of the sampling line P122 to allow isokinetic sampling. In addition, the sampling line P122 may be, for example, installed horizontally with respect to the ground with a length of about 70 cm so that air flow sampled may not be perturbed by the vehicle C. Accordingly, the air flowing in through the inlet hole P124 may form a laminar flow while passing through the sampling line P122 having a greater inner diameter than the inlet hole P124, and may keep the isokinetic sampling condition.

In addition, the sampling line P122 may have a Reynolds number of 2000 or less so that a uniform flow (laminar flow) may be formed. For this purpose, the sampling line P122 may have an inner diameter of about 48 mm, and the inlet hole P124 may have a diameter (about 10 mm) smaller than the inner diameter of the sampling line P122 by about ⅕. In the case of this inner diameter, for example, when a flow rate of about 65 L/min is sucked at a vehicle traveling speed of about 50 km/h, isokinetic sampling may be obtained. In the case of sampling flow rate of 65 L/min, the flow rate measured at the upstream of the ventilator should be about 42 L/min, which can be monitored with a laminar flow meter 170. When the vehicle speed increases or decreases, the sampling flow rate can be increased or decreased by using the ventilator controller 180 to keep isokinetic sampling condition.

Moreover, the particle sampling inlet tube P130 of the car chase mode may be configured identically to the particle sampling inlet tube P120 of the running mode so that isokinetic sampling may be obtained. In other words, as shown in the figures, the end (mouth) of the particle sampling inlet tube P130 of the car chase mode may be configured to have a decreased inner diameter. In addition, the particle sampling inlet tube P130 of the car chase mode may have both right and left branch tubes as described above. When the sum of flow rates sampled through both right and left branch tubes is about 65 L/min, the inner diameter of each branch tube may be about 25 mm so that a laminar flow may be formed in the branch tube, and in the case where the vehicle traveling speed is about 50 km/h, the end (mouth) of the sampling inlet tube P130 may have a decreased inner diameter of about 7.1 mm in order to obtain isokinetic sampling of the sample.

Meanwhile, in the case of the car chase mode, an auxiliary device such as a distance measuring device (e.g., a laser distance meter or the like) for measuring a distance to a target vehicle (a car to be tested) may be additionally included.

In addition, the multi-functional vehicle according to the present disclosure may further include a beta gauge 150 for continuously measuring the mass concentration of fine particulate matters (PM_{2.5}, PM₁₀ or the like), separately from the stop mode sampling inlet 110. In addition, a sampling inlet 140 for the beta gauge, which sucks fine particulate matters (PM_{2.5}, PM₁₀ or the like) may be installed. The sampling inlet 140 for the beta gauge may be installed vertically at the top of the vehicle C, namely at the roof of the vehicle C, and have a length of, for example, about 1.0 m.

Moreover, the multi-functional vehicle according to the present disclosure may further include a suspended road dust sampling inlet for investigating re-suspension of dust present on the surface of a road by a running car. The suspended road dust sampling inlet may be the same as disclosed in Korean Patent Registration No. 10-0582592, which may be mounted to the front of a bumper or the rear side of a tire of a measurement vehicle of the present disclosure. By using the suspended road dust sampling inlet, the number of suspended road dust particles, the distribution of particle diameters, the surface area of particles sticking to a human body, the concentration of soot included in the suspended road dust, concentrations of particle-bound polycyclic aromatic hydrocarbons (PAHs) or the like may be analyzed to obtain various information about the suspended road dust. The suspended road dust may contain particles generated by abrasion of tires, road surface, brake pads or the like, and the suspended road dust flowing in through the suspended road dust sampling inlet may be analyzed by the particle measuring device 400 loaded on the vehicle C.

Meanwhile, the flow distribution unit 200 communicates with the particle sampling inlet tubes P110, P120, P130 of each sampling inlet 110, 120, 130. Specifically, the flow distribution unit 200 supplies the air, flowing in from the particle sampling inlet tubes P110, P120, P130, to the particle measuring device 400.

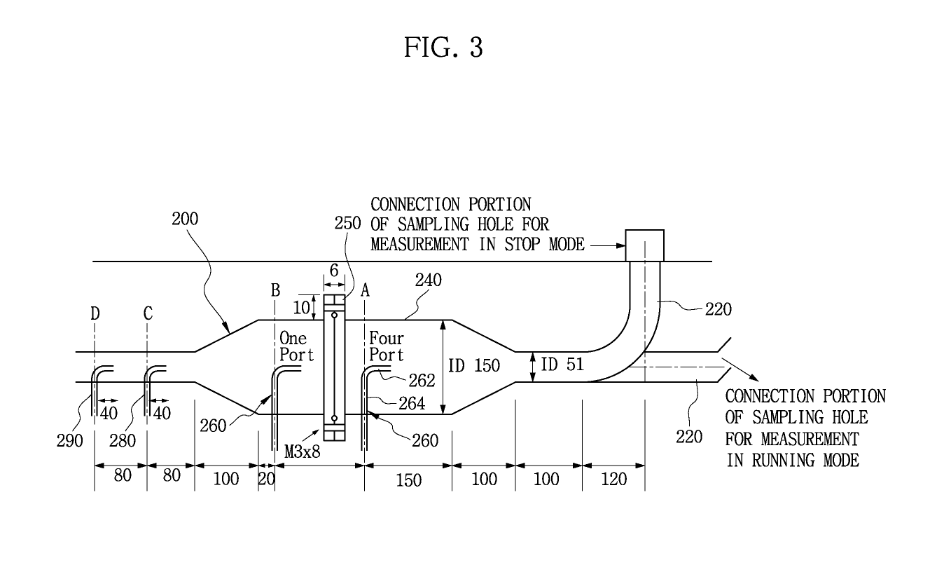

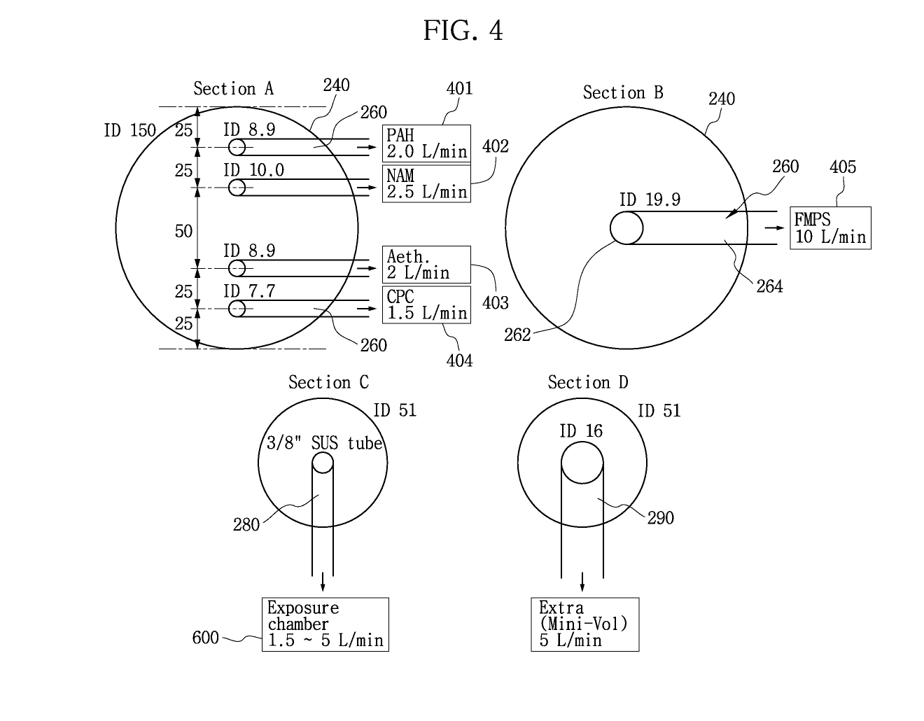

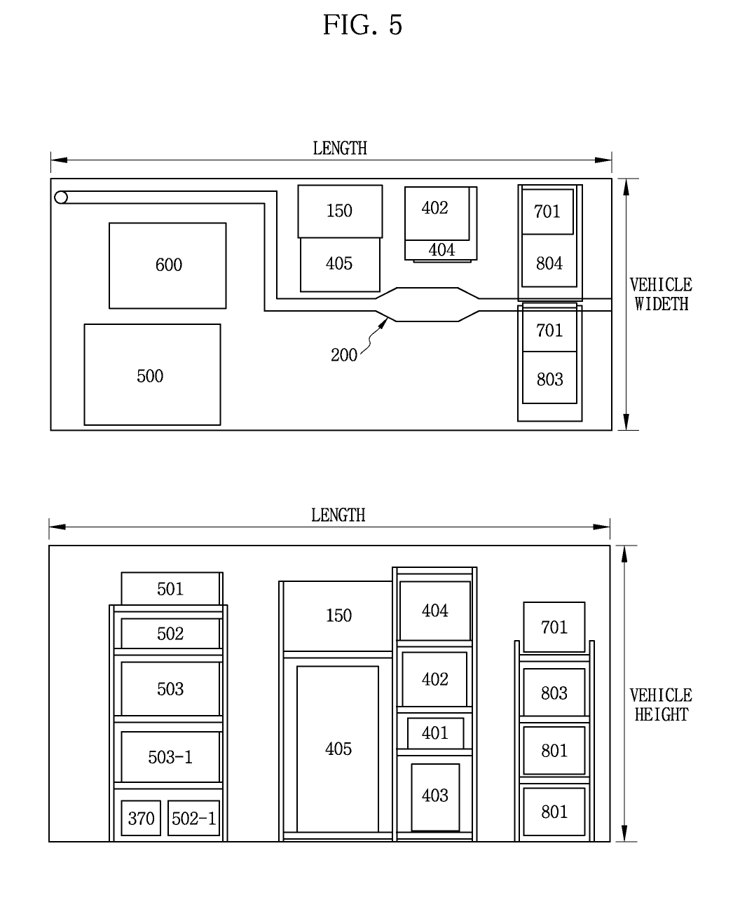

According to an embodiment, the flow distribution unit 200 includes a coupling tube 220 connected to the particle sampling inlet tubes P110, P120, P130, a flow distribution plenum 240 formed at the rear end of the coupling tube 220, and a sampling tube 260 for distributing the air flowing into the flow distribution plenum 240 to the particle measuring device 400. In addition, the flow distribution unit 200 may be classified into a front portion and a rear portion which are coupled by a joining member 250 as shown in FIG. 3. There are provided a plurality of sampling tubes 260, and the number of the sampling tubes 260 is determined according to the particle measurement items.

The flow distribution plenum 240 distributes the introduced air to the plurality of sampling tubes 260. The flow distribution plenum 240 has a greater inner diameter than the coupling tube 220 so that the air flowing in from the coupling tube 220 may have a slowing-down flow rate while keeping uniform flow (laminar flow). In addition, a ventilator 270 may be installed at the rear end of the flow distribution plenum 240.

The sampling tube 260 includes a sample inlet port 262, and a sample supply tube 264 extending from the sample inlet port 262 and supplying the air to the particle measuring device 400. The sample inlet port 262 is located at the center of the inner space of the flow distribution plenum 240. Accordingly, the air of a uniform flow (laminar flow) may flow in and be supplied to the particle measuring device 400.

There are provided a plurality of sampling tubes 260, and the number of sampling tubes 260 corresponds to the number of particle analyzers 401 to 405. In detail, the particle measuring device 400 may include a plurality of particle analyzers 401 to 405 according to the particle measurement items such as the number concentration and surface area of the particles, and the number of the sampling tubes 260 is identical to the number of the particle analyzers 401 to 405. Four sampling tubes 260 may be installed at the front side, and one sampling tube 260 may be installed at the rear side, for example.

The particle measuring device 400 may include a plurality of particle analyzers such as a PAH monitor 401, a nanoparticle aerosol monitor (NAM) 402, an aethalometer (Aeth) 403, a condensation particle counter (CPC) 404 and a fast mobility particle sizer (FMPS) 405, as common in the art. The flowing into the flow distribution plenum 240 is distributed through the sampling tube 260 to the particle counters 401 to 405. The coupling tube 220 has an inner diameter of about 48 mm, and the inner diameter of the flow distribution plenum 240 is increased to about 150 mm, thereby lowering the flow rate of the passing air to about 0.6 m/s or below. After that, the air is distributed through four sampling tubes 260 at the front to the PAH monitor 401, the NAM 402, the Aeth 403 and the CPC 404, which have relatively small sampling flow rates, and is distributed through one sampling tube 260 at the rear side to the FMPS 405 having the largest sampling flow rate, thereby sampling a flow rate of 10 L/min

In addition, the air flowing in through the gas sampling inlet tubes G110, G120, G130 is supplied through the manifold 300 to the gas measuring device 500. The gas measuring device 500 may include gas analyzers such as, for example, a CO/CO₂ analyzer 501, a NO/NO₂/NOₓ analyzer 502 and a total hydrocarbon(THC)/methane/non-methane hydrocarbon(NMHC) analyzer 503, as common in the art, and the air is distributed through the manifold 300 to each of the gas analyzers 501 to 503. The manifold 300 is not limited if it may distribute the air flowing in through the gas sampling inlet tubes G110, G120, G130 to the gas analyzers 501 to 503.

As shown in FIG. 2, the gas sampling inlet tubes G110, G120, G130 may be installed in parallel to the particle sampling inlet tubes P110, P120, P130. The gas sampling inlet tubes G110, G120, G130 may communicate with the manifold 300 through a connection tube, and a vacuum pump 370 may be installed at the rear end of the manifold 300. In addition, the air flowing into the manifold 300 may have a flow rate of several ten L/min, for example 20 to 80 L/min, and may be sampled to have a flow rate of 0.7 to 1.3 L/min at each gas analyzer, namely at the CO/CO₂ analyzer 501, the NO/NO₂/NOₓ analyzer 502, and the THC/methane/NMHC analyzer 503, respectively.

In addition, the particle measuring device 400 may be arranged in two rows at the left side from the center of the vehicle C. In detail, as shown in FIG. 5, the beta gauge 150 and the FMPS 405 may be arranged from the left top of the interior of the vehicle C, and the CPC 404, the NAM 402, the PAH monitor 401 and the Aeth 403 may be arranged in order from the right top thereof.

At each of the measuring devices 400, 500, the CPC 404 may employ one which may measure the total number concentration of particles having a size of 5 nm or above in the unit of particles/cm³ every second, and the FMPS 405 may employ one which may measure the size distribution of particles having diameters in the range of 5.6 to 560 nm in the unit of particles/cm³ every second. In addition, the NAM 402 may employ one which may measure the total surface area of particles that would be deposited to the bronchial tubes or lung of a human body in the unit of μm²/cm³ every second, the PAH monitor 401 may employ one which may measure the mass concentration of particle-bound PAHs present in a particulate phase in the unit of ng/m³ every seconds, and the Aeth 403 may employ one which may measure the mass concentration of black carbon or soot, known as causative materials of climate change, in the unit of ng/m³ every second. In addition, the beta gauge 150 may employ one which may measure the mass concentration of PM_{2.5} or PM₁₀ every 5 minutes according to the kind of an impacter mounted to the sampling inlet 140 for the beta gauge.

In addition, the gas measuring device 500 may be arranged at the rear right side of the vehicle C. For example, the CO/CO₂ analyzer 501, the NO/NO₂/NOₓ analyzer 502, and the THC/methane/NMHC analyzer 503 may be arranged in order from the top. In addition, a H₂ generator 503-1 may be disposed at the lower end of the THC/methane/NMHC analyzer 503 as an auxiliary device, and the vacuum pump 370 and an auxiliary part 502-1 of the NO/NO₂/NOₓ analyzer 502 may be disposed at the lower end of the H₂ generator 503-1.

When installing each of the measuring devices 400, 500, in order to minimize the possibility of breakage or malfunction caused by vibrations, the plate-type suspension system of the vehicle C may be exchanged with a pneumatic suspension system, an elastic body (for example, a vibration-absorbing spring or silicon rubber pad) may be laminated below the measuring device, and then each measuring device 400, 500 may be fixed to a metal frame by using a clamp.

Meanwhile, a part of the air passing through at least one selected from the flow distribution unit 200 and the manifold 300 is supplied to the animal exposure chamber 600. In addition, the remaining flow rate is exhausted via the ventilator 270 or the vacuum pump 370 to the outside of the vehicle C. At this time, the sampling flow rate of the ventilator 270 or the vacuum pump 370 may be adjusted by using a controller such as voltage adjuster or an inverter and valve. The sampling flow rate may be measured by using a hot wire flow velocimeter or checked by using a Venturi tube and a laminar flow meter 170.

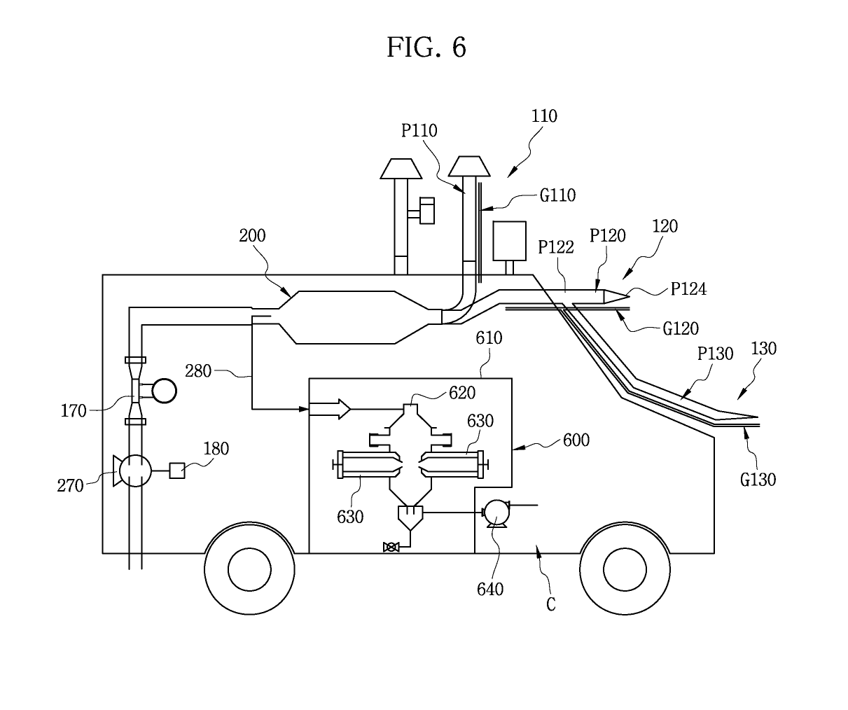

FIG. 6 shows an exemplary example of the animal exposure chamber system 600. The animal exposure chamber system 600 performs an animal exposure experiment, and may include a constant temperature chamber 610, and an air inlet portion 620 and an animal holder 630 installed in the constant temperature chamber 610. In addition, the animal exposure chamber system 600 may further include a discharge pump 640 installed out of the chamber 610. An experimental animal (e.g., an experimental mouse or the like) is present at the animal holder 630. A plurality of animal holders 630 may be arranged, for example six in two rows, respectively. The air flowing into the particle sampling inlet tubes P110, P120, P130 may be supplied through the branch tube 280 communicating with the flow distribution unit 200 to the animal exposure chamber system 600. The branch tube 280 may be configured identical to the sampling tube 260 described above. In addition, though not shown in FIG. 6, the air flowing into the gas sampling inlet tubes G110, G120, G130 may diverge from the manifold 300 and be supplied to the animal exposure chamber 600.

In addition, as shown in FIG. 2, a separate outlet tube 290 may be formed at the rear end of the flow distribution unit 200. Moreover, the outlet tube 290 may be configured identical to the sampling tube 260 described above. The air flowing in through the outlet tube 290 may be used for other measurements, for example other purpose such as sampling for analyzing shapes or chemical compositions of particles.

Moreover, the data management unit 700 may store and monitor the air pollution data measured by the particle measuring device 400 and the gas measuring device 500. Along with it, the data management unit 700 may have a function of transmitting the air pollution data with a control center (headquarter office) through a network. The air pollution data measured by the particle measuring device 400 and the gas measuring device 500 may be stored in a computer 701, displayed as a graph in real time, and monitored by the data management unit 700 by means of RS232C serial communication or A/D converter.

In addition, in the multi-functional vehicle according to the present disclosure, a GPS sensor 158 may be installed at a front dash board in the vehicle C. The data management unit 700 may store driving condition information and geographical information such as vehicle speed, vehicle acceleration, latitude, longitude, height or the like, measured by the GPS sensor 158. In addition, a weather sensor 159 for measuring weather elements may be installed on the roof of the vehicle C, and meteorological information such as wind direction, wind speed, temperature, relative humidity and rainfall, measured by the weather sensor 159, may be stored in the data management unit 700.

Additionally, in order to store road traffic situations and unusual situations at the measurement as images, a front CCTV 165 oriented to the front and a rear CCTV 166 oriented to the rear maybe installed beside the GPS sensor 158 to store images in an image storage device in real time, and wireless communication may be performed so that a control center (a headquarter office) may remotely monitor the situations by connecting to an Internet. In addition, the rear CCTV 166 may be connected to a door sensor as necessary to be utilized for preventing robbery.

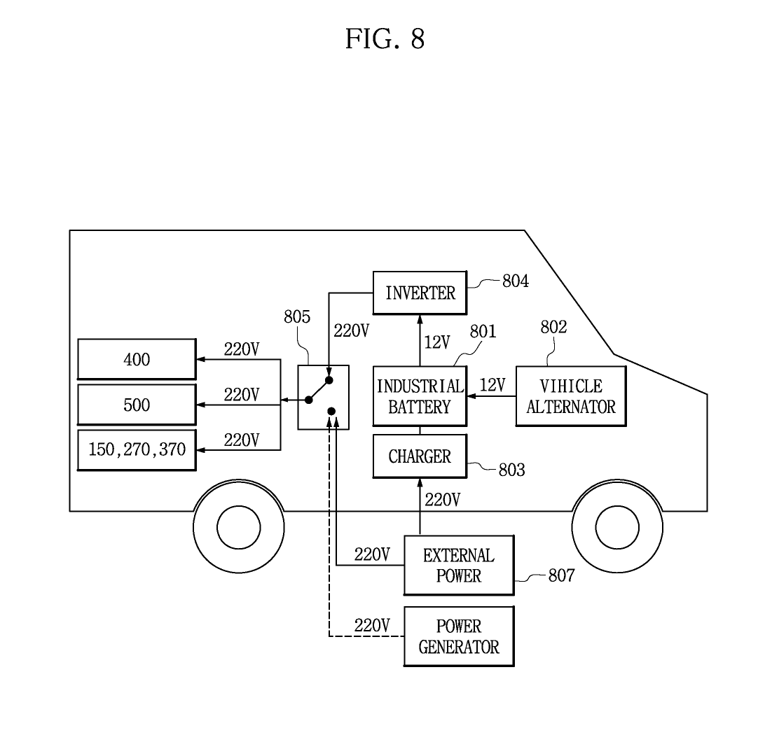

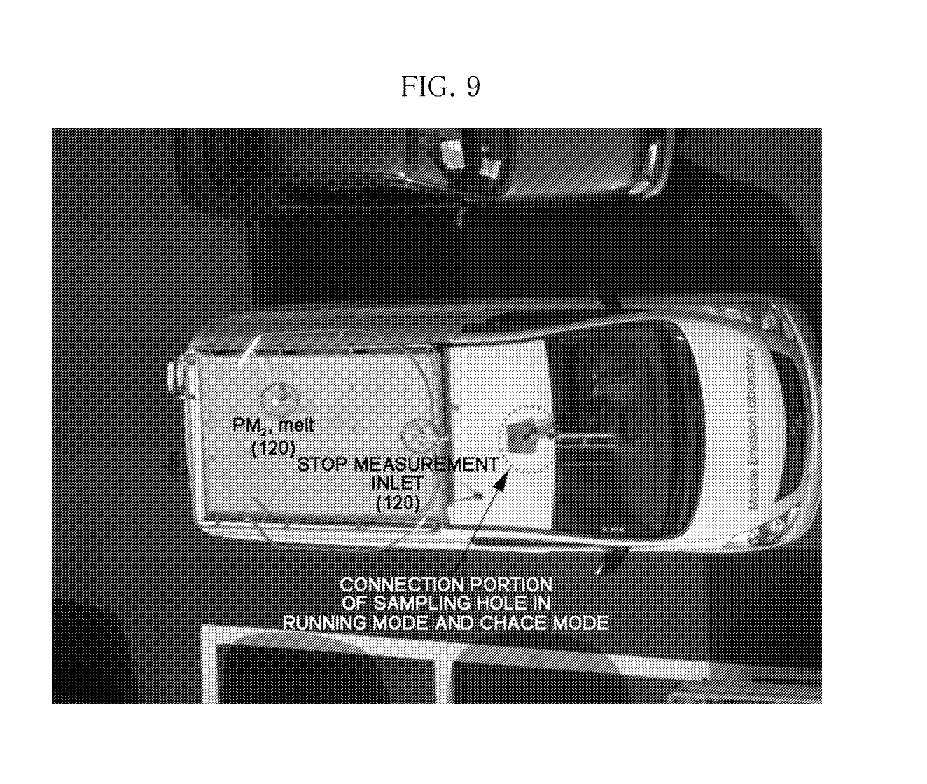

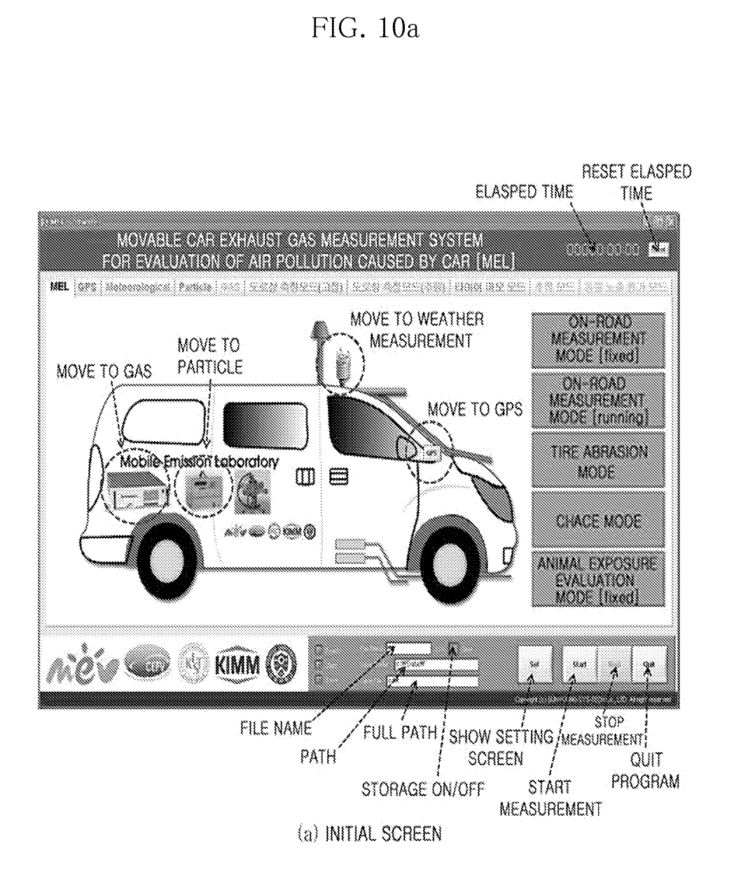

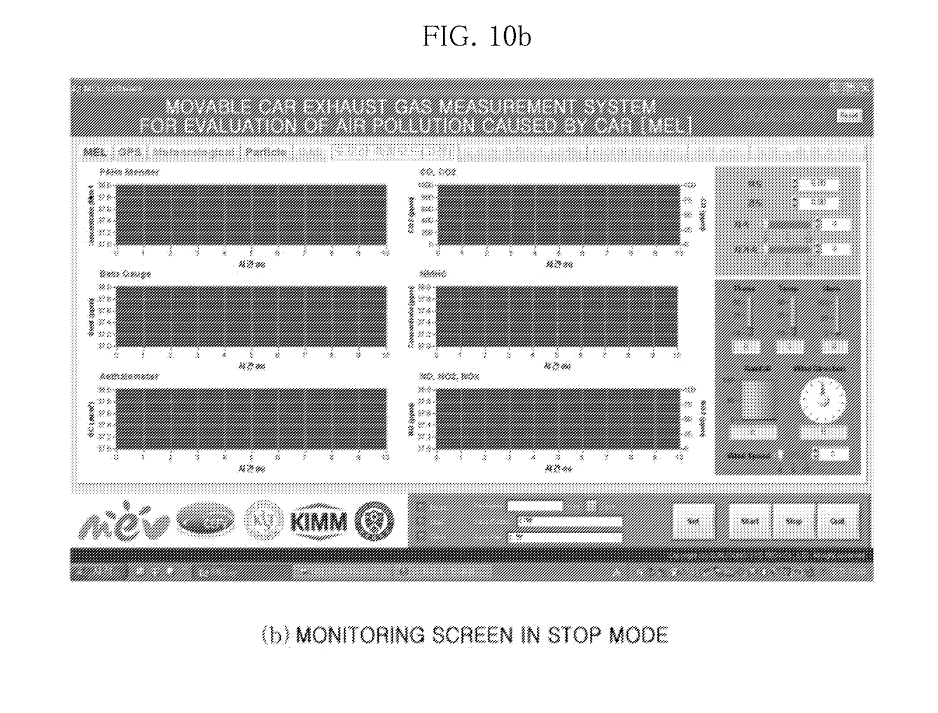

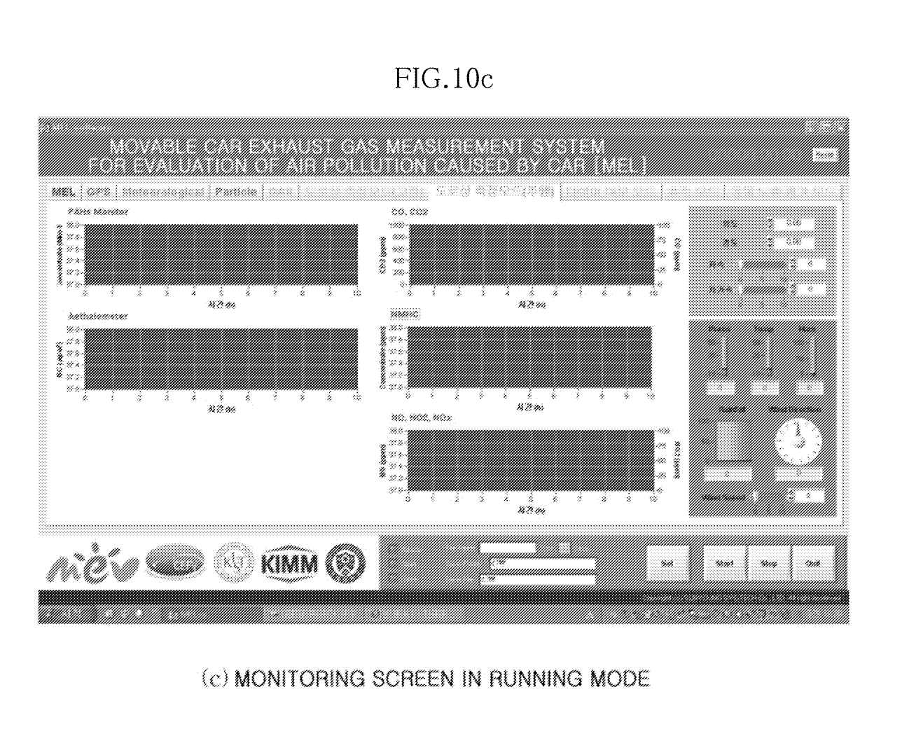

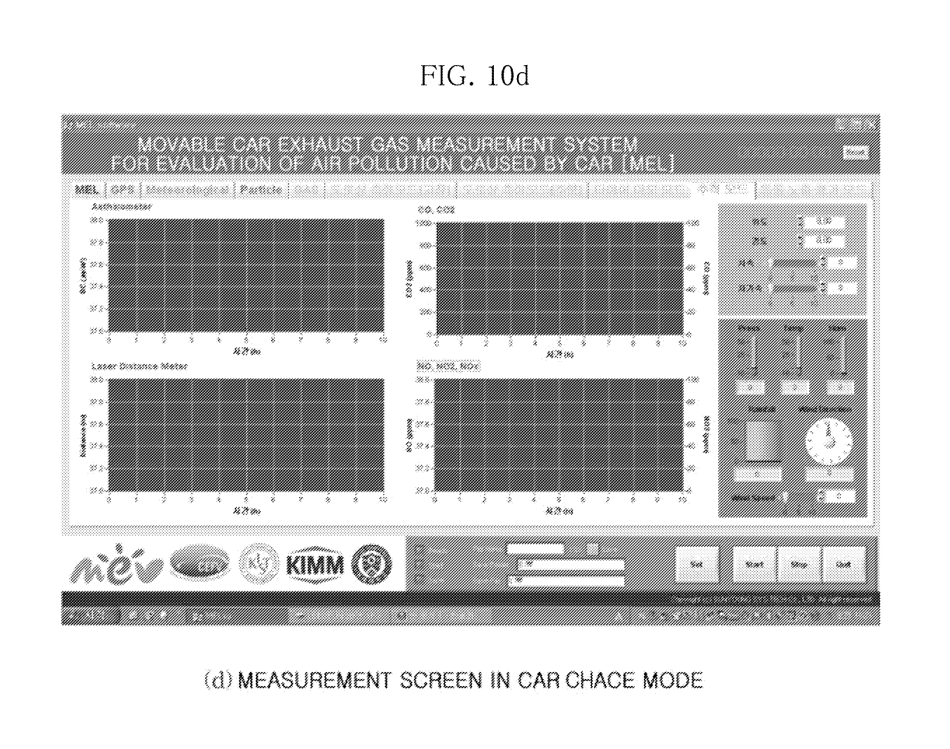

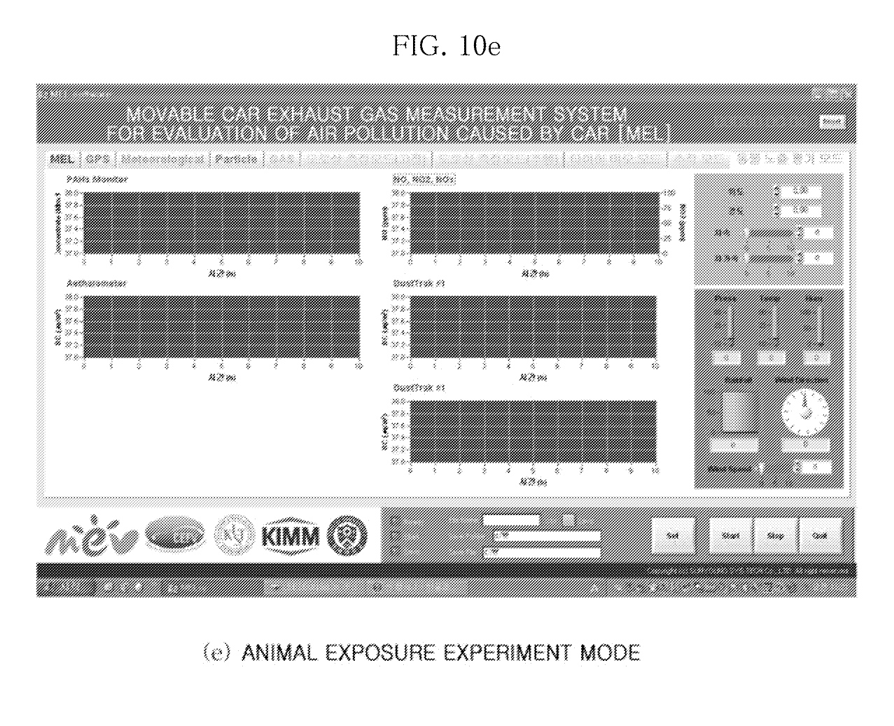

As described above, the multi-functional vehicle according to the present disclosure may include the power supply system 800 for supplying power. The power supply system 800 may be controlled by an integrated power management module 805 according to the measurement purpose and use time. FIG. 8 is a schematic view showing the power supply system 800.

Referring to FIGS. 1 and 8, the power supply system 800 supplies power from an industrial battery 801 mounted to the vehicle C, and the industrial battery 801 may be charged slowly by an alternator 802 of the vehicle while the vehicle is running In addition, if a power line of the battery charger 803 is connected to an external power 807, the industrial battery 801 may be charged. The power of 12V output from the industrial battery 801 is boosted to 220V by an inverter 804, and the boosted power is supplied to all measuring devices 150, 400, 500 and auxiliary devices. The auxiliary devices include the ventilator 270, the vacuum pump 370 or the like.

In addition, in the case of the running mode measurement and the car chase mode measurement, it is impossible to supply power from the outside, and so in this case, the components may be operated only by the industrial battery 801. Moreover, in the case of the stop mode measurement, instead of the battery, the integrated power management module 805 shifts the wiring so that the external power 807 may supply power to all measuring devices 400, 500 and auxiliary devices. If the power of the battery charger 803 turns on, the industrial battery 801 may be charged together.

In the present disclosure, the sampling inlet 100 includes the particle sampling inlet tubes P110, P120, P130 and the gas sampling inlet tubes G110, G120, G130 as two sampling inlet tubes at each sampling inlet 110, 120, 130, as follows.

The air pollutants emitted from a car is present in a particulate phase and a gaseous phase. In other words, in the exhaust gas, particulate pollutants such as soot, nanoparticle aerosol, and fine particulate matters (PM₁₀ or the like) and gaseous pollutants such as COₓ and NOₓ are mixed. The particulate pollutants and the gaseous pollutants have different physical or chemical properties. Therefore, in the case where the air flows in through a single sampling inlet tube and is measured as in the conventional case, the loss of air pollutants is great, and so the accuracy of pollution level measurement is low. In other words, a sampling inlet tube is generally formed of a metal or synthetic resin tube, and the particulate pollutants and the gaseous pollutants have different wall loss rates depending on the material of the sampling inlet tube. For example, the particulate pollutants such as fine particulate matters (PM₁₀ or the like) may be easily attached to synthetic resin material by means of static electricity or the like. Accordingly, in the case where the air flows in through a single sampling inlet and is measured as in the conventional case, a loss may occur in any one of the particulate substances and the gaseous substances depending on the material of the sampling inlet tube, which makes it difficult to accurately measure the air pollution level. However, in the case where the air flows in via separate lines through the particle sampling inlet tubes P110, P120, P130 and the gas sampling inlet tubes G110, G120, G130 and is measured according to the present disclosure, the loss caused by attachment or deposition of pollutants is low, and so it is possible to measure the air pollution level accurately.

According to an embodiment, the particle sampling inlet tubes P110, P120, P130 may be formed of metal material. In addition, the gas sampling inlet tubes G110, G120, G130 may be formed of synthetic resin. More specifically, the particle sampling inlet tubes P110, P120, P130 may be formed of stainless steel whose surface is electrolytically polished, and the gas sampling inlet tubes G110, G120, G130 may be formed of Teflon material. The stainless steel has a very low adsorption rate of particulate substances in comparison to other metals, and the Teflon material has a very low adsorption rate of gaseous substances in comparison to other synthetic resins. Therefore, they are useful for the present disclosure.

The present disclosure described above gives the following effects.

As described above, according to the present disclosure, when an external air flows in, since the air flows in via separate lines through the particle sampling inlet tubes P110, P120, P130 and the gas sampling inlet tubes G110, G120, G130, and the particle and the gas are measured separately, the loss caused by adsorption of air pollutants is low, and so it is possible to accurately measure the air pollution level. In addition, the concentration of air pollutants on a road actually having much traffic may be measured and analyzed in time and space by means of the running mode of the measurement vehicle and monitored in real time. In addition, the air pollution level at roadsides or on roads in a wide region may be measured within a short time, and since the air pollution level is stored in the data management unit 700 together with driving condition information, location information and weather information, it is possible to make a detailed air pollution level map and figure out spatial distribution characteristics.

In addition, emission characteristics of air pollutants according to the kind of a after-treatment device or driving conditions such as vehicle traveling speed of a target vehicle may be tested under a running condition on an actual road by means of the car chase mode, and the test results may be utilized for studying diffusion, dilution and transport of air pollutants exhausted from a car. Moreover, by directly exposing the air on the road, contaminated under an actual running condition, to an animal in the animal exposure chamber system 600, the health risk of the air pollutants exhausted from the car may be accurately evaluated and analyzed.

While the present disclosure has been described with respect to the specific embodiments, it will be apparent to those skilled in the art that various changes and modifications may be made without departing from the spirit and scope of the disclosure as defined in the following claims.

What is claimed is:

1. A multi-functional vehicle for measuring air pollution, comprising:
a sampling unit through an external air flows in, the sampling unit having a particle sampling inlet tube and a gas sampling inlet tube;
a flow distribution unit for supplying the air flowing in through the particle sampling inlet tube to a particle measuring device;
a manifold for supplying the air flowing in through the gas sampling inlet tube to a gas measuring device;
a particle measuring device for measuring concentrations of particles in the air supplied from the flow distribution unit;
a gas measuring device for measuring concentrations of gas in the air supplied from the manifold;
an animal exposure chamber system for receiving the air from at least one of the flow distribution unit and the manifold and performing an animal exposure experiment; and
a data management unit for storing and monitoring air pollution data measured by the particle measuring device and the gas measuring device.

2. The multi-functional vehicle for measuring air pollution according to claim 1, wherein the flow distribution unit includes:
a coupling tube connected to the particle sampling inlet tube;
a flow distribution plenum formed at the rear end of the coupling tube; and
a sampling tube for distributing the air flowing into the flow distribution plenum to the particle measuring device.

3. The multi-functional vehicle for measuring air pollution according to claim 2, wherein the sampling tube includes:
a sample inlet port located in an inner space of the flow distribution plenum; and
a sample supply tube extending from the sample inlet port and supplying the air to the particle measuring device.

4. The multi-functional vehicle for measuring air pollution according to claim 1, wherein the sampling unit is at least one selected from the groups consisting of a stop mode sampling inlet, a running mode sampling inlet and a car chase mode sampling inlet.

5. The multi-functional vehicle for measuring air pollution according to claim 4,
wherein the stop mode sampling inlet is mounted to an upper portion of the vehicle;
wherein the running mode sampling inlet is mounted to the front portion of the vehicle;
wherein the car chase mode sampling inlet is mounted to the front portion of the vehicle, so that an end of the sampling inlet is located at 0.3 to 1.5 m from the ground; and
wherein the optional sampling inlet is mounted to an upper portion of the vehicle for examining the effect of sampling height on the measured air pollution.

6. The multi-functional vehicle for measuring air pollution according to claim 1, wherein the particle sampling inlet tube includes:
a sampling line connected to the flow distribution unit; and
an inlet hole formed at the end of the sampling line and having a smaller inner diameter than the sampling line.

7. The multi-functional vehicle for measuring air pollution according to claim 6, wherein the sampling line includes:
an inlet hole whose diameter can meet the requirement for isokinetic sampling condition by controlling the air sampling flow rate that is monitored with a flow meter when the traveling speed of the multi-functional vehicle is changed.

8. The multi-functional vehicle for measuring air pollution according to claim 1, wherein the particle sampling inlet tube is formed of metal, and the gas sampling inlet tube is formed of synthetic resin.
